(19) United States
(12) Patent Application Publication
(10) Pub. No.: US 2012/0218122 A1
(43) Pub. Date: Aug. 30, 2012

(54) PARKING ENFORCEMENT SYSTEM AND METHOD

(76) Inventor: Albert BOGAARD, Atlanta, GA (US)

(21) Appl. No.: 13/404,217

(22) Filed: Feb. 24, 2012

Related U.S. Application Data
(60) Provisional application No. 61/446,908, filed on Feb. 25, 2011.

(51) Int. Cl. G08C 15/06

(52) U.S. Cl. 340/870.03; 340/870.02

(57) ABSTRACT

A parking enforcement system and method. The system and method may employ mobile technology and, in particular, a mobile device. From the perspective of the mobile device, a parking identifier is received, wherein the parking identifier corresponds with a parking space or corresponds with parking spaces. The mobile device then receives parking session information relating to the parking space or spaces corresponding with the parking identifier. The mobile device is capable of outputting this information in various forms to assist with parking enforcement. The parking session information may be transmitted to the mobile device from a network server in communication with the mobile device over the network.

### TECHNICAL FIELD

This invention relates generally to the digital parking field, and more specifically to a new and useful method of enforcing parking in the digital parking field.

### BACKGROUND

With the gradual adoption of digitized parking platforms, parking vendors require a method of determining which parked vehicles have digitally paid for a parking right. Additionally, because these systems are being slowly phased in, they oftentimes coexist with preexisting analog systems, many of which cannot digitally track legally occupied parking spaces (e.g., parking meters). Thus, there is a need in the parking enforcement field to create a new and useful method of determining which vehicles are legally parked.

### SUMMARY OF THE INVENTION

The present invention involves a parking enforcement system and method. The system generally involves a mobile device that receives parking identifier information and, based on the parking identifier information, it also receives parking session information. The parking session information may be stored in memory in or associated with a server that is directly or indirectly in communication with the mobile device over a network, e.g., a wireless network. The parking session information can then be used by a parking officer or attendant present at the parking location to enforce the parking rules.

In accordance with one aspect of the present invention, the objectives are achieved by a parking enforcement method for use with a mobile device. The method involves receiving, in the mobile device, a parking identifier. Subsequently, parking session information corresponding to the parking identifier is received by the mobile device. Then, based on the received parking session information, the mobile device outputs information indicating whether there is an active parking session associated with a parking location corresponding to the parking identifier.

In accordance with another aspect of the present invention, the objects are achieved by a parking enforcement method involving a server in communication with a mobile device over a network connection. The method, in turn, involves receiving a parking identifier from the mobile device. A memory is then searched for data associated with the parking identifier. Parking session information is then transmitted to the mobile device, where the parking session information is based on the data corresponding to the parking identifier stored in memory. Further, the parking session information indicates whether there is an active parking session associated with a parking location corresponding to the parking identifier.

### BRIEF DESCRIPTION OF THE FIGURES

FIG. 1 is a schematic representation of the parking enforcement method.

FIGS. 2A and 2B are schematic representations of a first and second embodiment of the step of receiving a parking identifier.

FIG. 3 is a schematic representation of the step of retrieving information from a server.

FIG. 4 is a schematic representation of an embodiment of the information received and stored by the server.

FIGS. 5A and 5B are schematic representations of a first and second embodiment of the step of displaying retrieved information.

FIG. 6 is a schematic representation of a second embodiment of the parking enforcement method.

### DESCRIPTION OF THE PREFERRED EMBODIMENTS

The following description of the preferred embodiments of the invention is not intended to limit the invention to these preferred embodiments, but rather to enable any person skilled in the art to make and use this invention. As a person skilled in the art will recognize from the previous detailed description and from the figures and claims, modifications and changes can be made to the preferred embodiments of the invention without departing from the scope of this invention defined in the following claims.

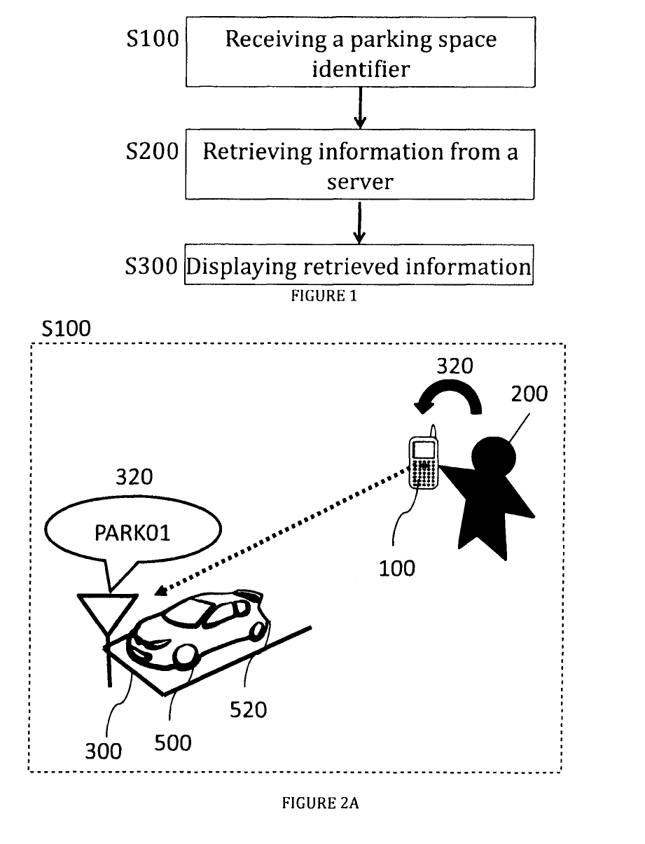

As shown in FIG. 1, the parking enforcement method comprises the steps of receiving a parking space identifier S100, retrieving information from a server S200, and displaying retrieved information S300. The parking enforcement method is preferably performed by a mobile computing device 100 such as a mobile phone, a smartphone, a tablet, a laptop, or any other computing device capable of wireless communication with a server 400 and saving data. The method is preferably utilized in conjunction with at least one digital parking system (DPS) 220 that allows the owner or user of a vehicle 500 to digitally pay for a parking right (i.e. ability to park a vehicle 500 in the parking space 300 without adverse consequences, such as ticketing or towing), wherein the conferment of the parking right is stored on the server 400. Examples of such systems include pay-by-phone systems such as the Parkmobile system, mobile computing payment systems (e.g. the system described in U.S. application Ser. No. 12/949,647, incorporated in its entirety by this reference), or any other parking payment system that enables digital payment of a parking fee, wherein the digital payment is recorded in a remote server 400. The method is preferably used by a parking enforcement officer 200 (“officer”) affiliated with a parking vendor 240 (i.e., an entity that provides parking rights to the parking spaces 300) to determine which parked vehicles 500 have purchased parking rights, but may alternately be used directly by the parking vendor 240 to determine which vehicles 500 have purchased parking rights. The method may additionally be used by the parking vendor 240 to determine other parking-related information, such as the number of individual parking spaces 300 currently available or peak demand times. Parking vendors 240 that utilize this method preferably include parking lot operators, parking zone (e.g., residential street parking) operators, and metered parking operators, but may additionally include any other parking vendor 240 that provides a payment-for-parking service. In the context of this application, the parking space 300 provided by the parking vendor 240 is preferably a parking area that accommodates one vehicle 500, but may alternately be an area that accommodates multiple vehicles 500 (e.g., a parking lot or zone).

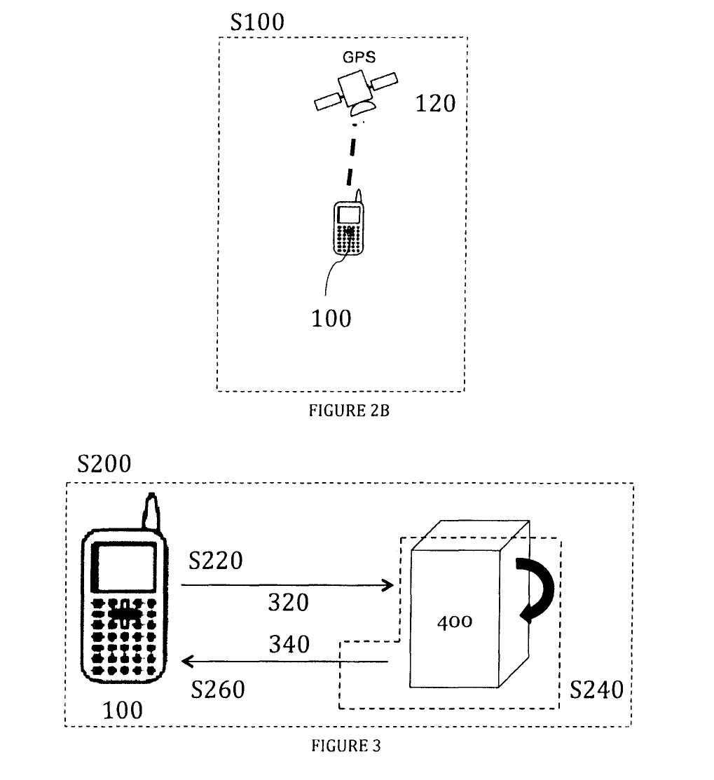

As shown in FIGS. 2A and 2B, the step of receiving a parking space identifier S100 functions to identify the parking space 300 in accordance with exemplary embodiments of the parking enforcement method of the present invention. Preferably, this step is performed by the mobile computing device 100 and preferably accomplished by receiving a parking space identifier 320 input from the parking officer 200, but may alternately be automatically obtained. While one parking space identifier 320 is preferably received, multiple parking space identifiers 320 or a range of parking space identifiers 320 may alternately be received. As shown in FIG. 2A, the officer 200 may input the identifier by typing in the identifier (e.g. an alphanumeric code), but may alternately input the parking space identifier 320 by recording an image, recording an audio clip (e.g. reading out the parking space identifier 320), or selecting a pre-stored identifier on the mobile computing device 100. However, as shown in FIG. 2B, the parking space identifier 320 may alternately be received automatically, such as through an RF signal spatially coupled to the parking space 300, a GPS 120 reading, or a WiFi position. The parking space identifier 320 is preferably an alphanumeric code, but may alternately be a QR code, a barcode, an RF tag, or the parking space's 300 geographical location. This step is preferably performed each time the officer 200 attempts to verify whether a vehicle 500 is associated with an active parking session, but may alternately be performed before the officer 200 begins any enforcement activities (e.g. before the officer 200 enters the parking lot or checks any vehicles 500) or during active enforcement.

As shown in FIG. 3, the step of retrieving information from a server S200 functions to provide the active parking sessions associated with the parking space 300 to the mobile computing device 100. This step preferably comprises the substeps of the mobile computing device sending the received identifier to the server S220, the server searching a list for the identifier and sending the active parking session information to the mobile computing device S240, and the mobile computing device receiving the information S260. The sending and receiving steps are preferably performed wirelessly, such as through a local area network, a WiFi connection or a mobile wireless communication service (e.g. CDMA or GSM), but may alternately be performed through a wired connection, wherein this step is performed before the officer 200 performs any parking enforcement actions (e.g. checking the parking space 300 for illegally parked cars).

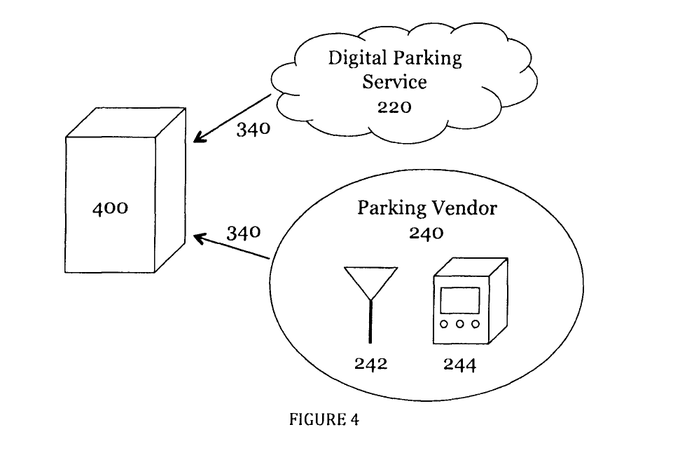

As shown in FIG. 4, the server 400 is preferably a server 400 associated with the DPS 220, wherein the parking session information 340 is received by the server 400 from both the DPS 220 and the parking vendor 240 (e.g. the parking vendor 240 sends the DPS 220 active parking session information 340 or the parking meter 242/kiosk 244 sends parking session information 340 to the DPS 220). Alternately, the server 400 may contain only one DPS's 220 parking session information 340, or may contain multiple DPSs' 220 parking session information 340. The server 400 may alternately be associated with the vendor, wherein the DPS 220 sends parking session information 340 to the vendor's server 400. The parking session information 340 is preferably sent to the server 400 at a set frequency, but may alternately be sent every time a new parking session is initiated. This step is preferably performed by the mobile computing device 100 for a single server 400, but may alternately be performed by the mobile computing device 100 for multiple servers 400, wherein the servers 400 of multiple parking services are accessed and data retrieved. The information retrieved by the mobile device preferably comprises of a vehicle identifier 520 and a start time for the parking session. However, the information may additionally include a parking space identifier 320, an end time for the parking session, the vehicle 500 registration information, the timezone, a description of the parking session, or any other information pertinent to parking enforcement. The retrieved information is preferably on a per-vehicle 500 basis (e.g. only one vehicle's 500 parking session information 340 is retrieved per query), but may alternately be on a parking space 300 basis (e.g. all the active parking sessions associated with either the parking space 300, or range of parking spaces 300 are retrieved) or on a vendor basis (e.g. all the active parking sessions associated with all the parking vendor 240's parking spaces 300 are retrieved). In the latter two cases, the information is preferably retrieved as a searchable list.

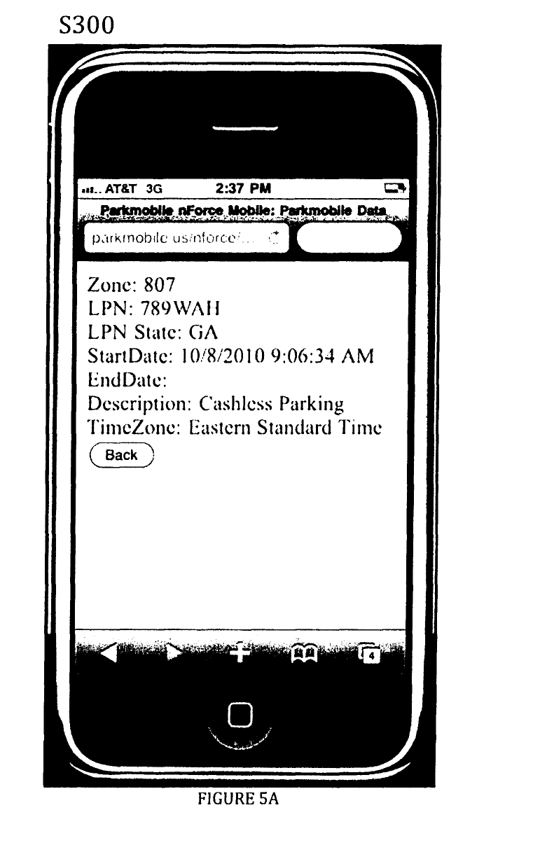

As shown in FIGS. 5A and 5B, the step of displaying retrieved information S300 functions to allow the officer 200 to determine whether the vehicle 500 has paid for a parking right. The displayed information preferably includes a vehicle identifier 520 and the remaining time duration for the parking session, but may additionally include the parking space identifier 320, the start time, the end time, the time zone, the vehicle 500 registration information, or any other information pertinent to parking enforcement. However, the displayed information may alternately be a list of the occupied parking spaces 300, a list of the available parking spaces 300, a list of the vehicles 500 with parking rights to the parking space 300, or any other synthesis of the retrieved information suitable for aiding parking enforcement. The information is preferably displayed by the mobile computing device 100 as a list of information for a single parking session (shown in FIG. 5A), but may alternately be displayed as a graphical image (e.g. a map indicating which parking spaces 300 are taken, shown in FIG. 5B), or as a list of information for multiple sessions, zones, or vehicles.

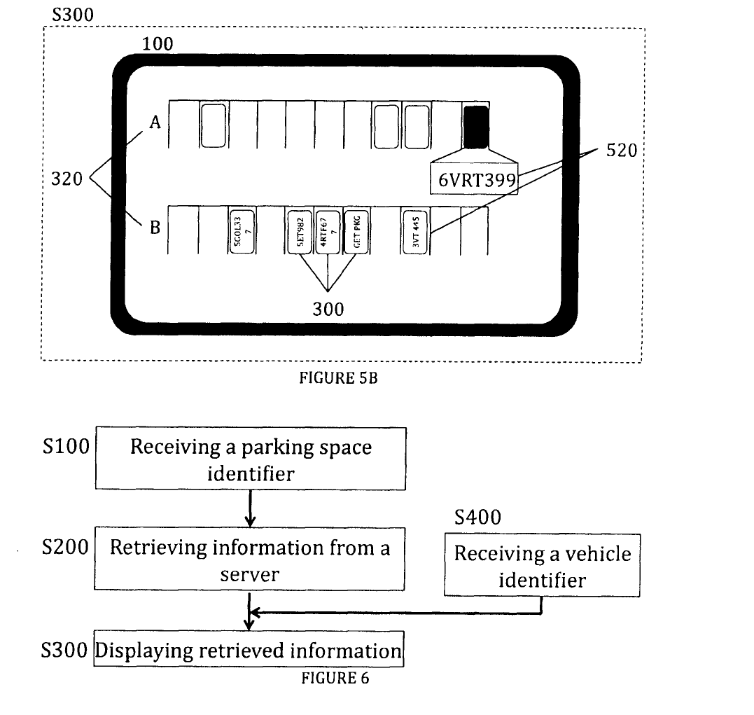

The parking enforcement method may additionally include the step of receiving a vehicle identifier S400, as shown in FIG. 6. The vehicle identifier 520 is preferably received substantially immediately after a vehicle identifier 520 entered by the officer 200 into the mobile computing device 100 by typing in a license plate number (LPN), but may alternately be received by the officer 200 typing in the vehicle 500 identification number (VIN), by the officer 200 taking a picture of the license plate, by the officer 200 taking a picture of the vehicle 500, by receiving a RF signal associated with the vehicle 500, or receiving any other form of vehicle 500 identification. This step is preferably performed after the step of retrieving information from a server S200, wherein the method includes the additional steps of: searching through the retrieved information for the vehicle identifier 520; and either returning the associated information if the vehicle 500 is found or communicating (e.g. displaying a message or color, vibrating, playing an audio clip, etc.) that the vehicle 500 is not found in the retrieved information. The method may further include the steps of accessing vehicle registration information based on the vehicle identifier 520 and printing out a parking ticket. However, this step may be performed concurrently with or after the step of receiving a parking space identifier S100, or after the step of displaying the retrieved information S300.

As a person skilled in the art will recognize from the previous detailed description and from the figures and claims, modifications and changes can be made to the preferred embodiments of the invention without departing from the scope of this invention defined in the following claims.

What is claimed is:

1. A parking enforcement method for use with a mobile device, said method comprising:
receiving, in the mobile device, a parking identifier;
receiving, in the mobile device, parking session information corresponding to the parking identifier; and
based on the received parking session information, outputting information indicating whether there is an active parking session associated with a parking location corresponding to the parking identifier.

2. The parking enforcement method of claim 1, wherein the parking location corresponds to multiple parking spaces, and wherein the information indicating whether there is an active parking session, includes information relating to each of the multiple parking spaces.

3. The parking enforcement method of claim 2, wherein outputting information indicating whether there is an active parking session comprises:
displaying the information indicating whether there is an active parking session associated with each of the multiple parking spaces.

4. The parking enforcement method of claim 3, wherein displaying the information comprises:
displaying the multiple parking spaces in the form of a graphical representation of the multiple parking spaces.

5. The parking enforcement method of claim 3, wherein displaying the information comprises:
displaying the multiple parking spaces in the form of a list including each of the multiple parking spaces.

6. The parking enforcement method of claim 1, wherein receiving a parking identifier comprises:
receiving an input signal encoded with the parking identifier.

7. The parking enforcement method of claim 6, wherein the encoded input signal reflects one of a bar code, a QR code or an alpha-numeric code, each of which reflect the parking identifier.

8. The parking enforcement method of claim 6, wherein receiving an input signal encoded with the parking identifier comprises:
receiving a wireless signal.

9. The parking enforcement method of claim 8, wherein receiving a wireless signal comprises:
receiving an RF tag that reflects the parking identifier.

10. The parking enforcement method of claim 1, wherein receiving a parking identifier comprises:
receiving a manual input the reflects the parking identifier.

11. The parking enforcement method of claim 1, wherein receiving a parking identifier comprises:
receiving a geographic location that reflects the parking identifier.

12. The parking enforcement method of claim 1, wherein receiving parking session information comprises:
receiving the parking session information from a server over a wireless network connection.

13. The parking enforcement method of claim 12, wherein the parking session information comprises at least one of a vehicle identifier, a parking session start time, a parking session end time, the parking identifier and time zone.

14. The parking enforcement method of claim 12 further comprising:
sending the parking identifier to the server over a wireless network connection, wherein receiving the parking session information over a wireless network connection from the server is in response to the sending of the parking identifier to the server.

15. The parking enforcement method of claim 12 further comprising:
periodically receiving parking session information from the server over a wireless network connection.

16. A parking enforcement method for a server in communication with a mobile device over a network connection, said method comprising:
receiving a parking identifier from the mobile device:
searching data, stored in a memory, for the parking identifier; and
transmitting parking session information to the mobile device, wherein the parking session information is based on the data corresponding to the parking identifier stored in memory, and wherein the parking session information indicates whether there is an active parking session associated with a parking location corresponding to the parking identifier.

17. The parking enforcement method of claim 16, wherein receiving a parking identifier from the mobile device comprises:
receiving an input signal encoded with the parking identifier.

18. The parking enforcement method of claim 17, wherein the encoded input signal reflects one of a bar code, a QR code or an alpha-numeric code, each of which reflect the parking identifier.

19. The parking enforcement method of claim 16, wherein the parking location corresponds to multiple parking spaces, and wherein the information indicating whether there is an active parking session, includes information relating to each of the multiple parking spaces.

20. The parking enforcement method of claim 19, wherein the parking session information comprises at least one of a vehicle identifier, a parking session start time, a parking session end time, the parking identifier and time zone.

21. The parking enforcement method of claim 16, wherein transmitting parking session information to the mobile device comprises:
periodically transmitting parking session information indicating whether there is an active parking session associated with a parking location corresponding to the parking identifier.

22. The parking enforcement method of claim 16 further comprising:
receiving the parking session information from a second server and storing the parking session information in the memory.
